(19) United States
(12) Patent Application Publication
(10) Pub. No.: US 2003/0141620 A1
(43) Pub. Date: Jul. 31, 2003

(54) Surfacing of polyolefin objects with antimicrobial material

(76) Inventors: Michael J. Stevenson, Sedona, AZ (US); Robert Alan Reeves, Cottonwood, AZ (US)

Correspondence Address: Robert E. Strauss MOLD IN GRAPHICS SYSTEMS, P.O. BOX 1650, Clarkdale, AZ, 86324, US

(21) Appl. No.: 10/058,257

(22) Filed: Jan. 29, 2002

(51) Int. Cl. B29C 41/04

(52) U.S. Cl. 264/129; 264/308; 264/310

(57) ABSTRACT

Anti-microbial activity is permanently applied to the surfaces of polyolefin objects by incorporating anti-microbial metals and metal salts into the surfaces. This is achieved by coating the selected surface of a preformed polyolefin part with the anti-microbial composition of this invention and then heating the surface of the object to fuse the coating into the polyolefin wall. Alternatively, the composition can be applied to the interior surface of a manufacturing mold at the start of the molding cycle from where it is incorporated into the wall of the molded object during its manufacture. The antimicrobial composition comprises from 0.5 to 5 weight percent of an anti-microbial additive in a hydrocarbon resin or polyolefin having a low melt index. This composition can be diluted with an organic or aqueous carrier for ease of application.

### BACKGROUND OF THE INVENTION

1. Field of Invention

This invention relates to molded polyolefin parts and, in particular, to a method for permanently imparting antimicrobial activity to surfaces of polyolefin parts, especially polyethylene parts.

2. Brief Statement of the Prior Art

Certain metallic elements and salts are known to possess anti-microbial activity and recent advances have used zeolites and ion exchange solids as carriers for active metal salts which are used as additives for coatings; see U.S. Pat. Nos. 5,151,122; 5,556,669; 4,938,958; 4,938,955; and 4,906,464.

Many articles which could be enhanced with an anti-microbial surface are molded of polyolefins. Polyethylene is usually the polyolefin of choice as it has desirable properties and relative low cost. Examples of products molded of polyolefins which could be enhanced with anti-microbial surfaces include diaper changing stations, bathroom fixtures, trash receptacles, playground equipment, medical and dental equipment such as backboards and stretchers, commercial and residential food handling equipment such as food and ice receptacles, cutting boards, etc. Many of these products are formed by rotational molding or thermoforming, which are useful to manufacture large objects. Rotational molding is used to manufacture hollow-form parts such as receptacles while thermoforming is used to manufacture large, flat objects. Other manufacturing processes include blow molding, injection molding, and extrusion of polyolefins.

Surfaces of polyolefins, particularly polyethylene, however, are non-receptive to coatings. Loading the molding resin with an amount of anti-microbial salt sufficient to impart anti-microbial activity is of limited efficacy, often degrades the physical properties of the resin and is too costly. Consequently, heretofore there has been no known manner to impart permanent, anti-microbial activity to surfaces of polyolefins.

Techniques have been developed for permanently decorating polyolefin surfaces. U.S. Pat. No. 4,352,762 describes and claims a method in which decorative or alphanumerical indica are applied as a viscous oil suspension to the interior surface of a rotational mold by silk screen printing for transfer to the molded part during molding. Further developments of this approach have included using transfers having indica contained in a mixture of waxy material and polyolefin powders printed on a carrier sheet to apply the indica onto the interior surface of the mold; see U.S. Pat. No. 4,519,972. U.S. Patent discloses and claims a method for the application of indica to the surface of a molded polyolefin part using a similar transfer. These developments spurned other developments such as disclosed in U.S. Pat. Nos. 5,648,030 and 5,498,307.

None of the aforementioned approaches has addressed the problems and objectives of incorporating a permanent anti-microbial activity to the surfaces of polyolefin parts.

### OBJECTIVES OF THE INVENTION

It is an objective of this invention to provide a method to impart permanent anti-microbial activity to the surfaces of polyolefin, particularly polyethylene, parts.

It is an additional objective of this invention to apply a method to impart permanent anti-microbial activity to the surfaces of polyolefin parts during rotational molding or thermoforming.

It is a further objective of this invention to provide a method to impart permanent anti-microbial activity to the surfaces of polyolefin parts after their fabrication by any of the various molding processes.

Other and related objectives will be apparent from the following description of the invention.

### BRIEF DESCRIPTION OF THE INVENTION

Anti-microbial activity is permanently applied to the surfaces of polyolefin objects by incorporating anti-microbial metals and metal salts into the surfaces. This can be achieved by coating the selected surface of a preformed polyolefin part with the anti-microbial composition of this invention and then heating the surface of the object to fuse the coating into the polyolefin wall. Alternatively, the coating can be applied to the interior surface of a manufacturing mold at the start of the molding cycle from where it is incorporated into the wall of the molded object during its manufacture. The antimicrobial composition comprises from 0.5 to 5 weight percent of an anti-microbial additive in a hydrocarbon resin or polyolefin having a low melt index. This composition can be diluted with an organic or aqueous carrier for ease of application.

### DESCRIPTION OF THE PREFERRED EMBODIMENTS

The invention is useful to impart permanent anti-microbial activity to the surface of polyolefin parts. As used herein, permanent is used to indicate a treatment which is resistant to removal by wear, weathering, abrasion, or leaching.

The invention can be applied as a post molding treatment of polyolefin parts which have been formed in conventional molding operations such as rotational molding, thermoforming, injection molding or blow molding. The invention can also be applied during a rotational molding or a thermoforming cycle.

In rotational molding, hollow-form plastic parts are formed by charging polyolefin particles to a rotational mold, closing and heating the mold to the molding temperature of the polyolefin while being rotating the mold about its major and minor axes for a time sufficient to form the molded part. The mold is then cooled to a demolding temperature, opened and the molded product is ejected. In thermoforming, a polyolefin sheet is heated to a pliable state and is then pressed against a forming die.

The anti-microbial composition used in the invention is a mixture of an anti-microbial agent and a polyolefin fusible solid having a low melt index. The anti-microbial agent comprises a solid carrier in a finely subdivided state containing from 0.05 to 15 weight percent of an anti-microbial metal, oxide, salt or complex. Useful metals which have anti-microbial activity include silver, zinc, copper, cadmium, lead and mercury. Preferably the metal is deposited or ion exchanged onto the solid carrier from a solution of a water soluble salt of the metal ions or of ionic complexes of the metal. Useful solid carriers include clays, activated clays, silica gel, zeolites, and other ion exchange solids such as zirconium phosphates. Alumino-silicate zeolite is the preferred carrier and the active metal ions are preferably ion-exchanged onto the carrier from a water soluble solution of a salt of the metal ions or complex metal ions. The particles of the solid carrier should have a size range from about 1 to 100 microns, preferably from 1 to about 10 microns.

The polyolefin fusible solid can be a hydrocarbon resin or polyolefin of high viscosity. The polyolefin should have a low melt index, preferably below 30, and most preferably below 20 grams/minute, The viscosity of hydrocarbon resins is usually expressed as Brookfield viscosity, and the Brookfield viscosity of suitable hydrocarbon resins should be no less than about 50 centipoise at 175-180 degrees C. The property of high viscosity or low melt index is significant in this application as a solid with lesser viscosity will tend to encapsulate the anti-microbial additive and seal the active metal ions from the surface of the treated polyolefin object.

The polyolefin fusible solid is a hydrocarbon resin or polyolefin which is transparent or lightly colored so as to avoid any coloration or shading of the polyolefin object, which has high heat and ultraviolet light stability and which is soluble in hydrocarbon solvents or readily dispersible in water for ease of application as described hereinafter. The polyolefin fusible solid is used in a finely subdivided state, as a powder with an average size from about 1 micron to 120 microns and a non-angular shape, preferably a spherical shape.

Examples of polyolefins which can be used include homoand co-polymers of olefins such as high density, linear low density, low density, cross-linkable polyethylene, metallocene modified polyethylene, ethylene-vinyl acetate copolymer, ethylene-butyl acrylate copolymer, polypropylene, etc. The polyolefin can be selected for the application to match the properties of the base polymer, e.g., to match shrinkage, impact and tensile strengths, toughness, etc. of the polymer used to form the molded object. Usually the matching will be based on using the same type of polymer as the base polymer used for molding the part such as using polypropylene powder for polypropylene parts and polyethylene for polyethylene parts.

Useful hydrocarbon resins should have a softening temperature less than the melting temperature of the base polymer used to form the polyolefin object, which for polyethylene particles should be less than 250 degrees F. Useful hydrocarbon resins include polyacrylic acid, polyacrylates, polyurethanes, poly(vinyl)acetate and copolymers and mixtures thereof. Aliphatic or cycloaliphatic petroleum resins from five carbon monomers containing minor amounts of aromatics, synthetic terpene resins, chlorinated polyolefins and hydrogenated rosin and rosin esters are preferred.

The anti-microbial additive and polyolefin fusible solid can be admixed by compounding with the anti-microbial solid being added to molten polyolefin fusible solid and the resultant mixture atomized to form the preferred non-angular particles with average diameters from 1 to about 120 microns. Alternatively, the anti-microbial additive and polyolefin fusible solid are admixed in a liquid carrier which can be an organic solvent or water at concentrations up to about 85 weight percent solids, the amount of liquid carrier being sufficient to form a stable solution or dispersion.

Examples of suitable solvents include hydrocarbon solvents such as hexane, benzene, etc. When water is used as the liquid carrier, the anti-microbial composition is dispersed in water with surface active agents which can include hydrocarbon silicone and fluorocarbon surfactants, non-ionic surfactants and ionic surfactants. Sufficient amounts of the surfactant are used to achieve a stable suspension of the composition in the aqueous mixture. Typically, the effective concentration of the surfactant will be from 0.1 to about 2 weight percent of the content of the composition in the aqueous mixture, depending on the particular surfactant which is used.

For application of the composition, it is preferred to dissolve the anti-microbial composition in a volatile solvent, or suspend the composition in water using a surfactant as needed to form a stable dispersion. The liquid carrier is used in sufficient quantity to permit application of the composition to the surface of a manufacturing mold by spraying or brushing, or to the surface of a preformed polyolefin part by spraying, brushing or dipping.

The composition can be diluted to concentrations from 15 to 65 weight percent in a solvent or water, depending on the application method. Preferably the composition is used at its maximum content to minimize the amount of solvent or water which must be evaporated after application. The preferred application is spraying and for this application from 20 to 50, preferably from 25 to 35, weight percent of the composition is used in a volatile solvent such as hexane, or most preferably, in water. Spraying the composition forms coatings of the composition which have a thickness from 0.1 to about 1 mil. Slightly thicker films, up to about 5 mils can be formed by brushing or rolling the composition.

The anti-microbial composition can be applied to the inside surface of a rotational mold to incorporate the composition elements into the outside surface of a molded part during its formation, or can be post-mold applied to a formed part.

The anti-microbial composition can be readily applied to the internal surface of molds used in rotational molding by spraying or brushing a solution or aqueous suspension of the composition. The preferred application is spraying and sufficient liquid carrier is used to form a sprayable mixture containing the composition. The liquid carrier quickly evaporates, leaving a thin coating of the anti-microbial composition on the surface of the mold. Thereafter, the steps and conditions typically practiced with rotational molding can be practiced, i.e., charging the mold with molding resin, typically polyethylene resin particles with sizes from 16 to 60, usually 35 mesh, closing the mold and heating it to the molding temperatures while rotating the mold about its major and minor axes for the time and at the temperature conditions tailored for the particular product and molding resin. During the molding cycle, the anti-microbial composition transfers to the part and becomes permanently incorporated into surface of the part. At the completion of the molding cycle, the mold is cooled, opened and the part is ejected.

The anti-microbial composition can also be applied to a preformed part obtained by otherwise conventional molding such as rotational molding, thermoforming, blow molding, injection molding, etc. In this application, a polyolefin is used as the major, or only fusible solid, with the anti-microbial additive to form the anti-microbial composition. Preferably the composition is applied by spraying and a liquid carrier is added as necessary. The surface of the part coated with the composition is then heated to raise the temperature of the coating and outer skin of the surface to the melt temperature of the polyolefin powders, fusing the coating into the outer skin of the polyolefin surface. The anti-microbial particles are thereby permanently bonded into the outer skin of the polyolefin part, yet remain active by releasing ions of the bioactive metal to the outer surface of the part. In a typical application, the coated polyolefin surface is heated to a temperature from 250 to about 550 degrees F., taking care to avoid excessive temperatures or temperature differentials which could cause the polyolefin part to distort or warp.

The heating can be accomplished using a suitable radiant source such as an open flame or a high temperature electrical heater, e.g., an infrared heater. The heating step is practiced to apply heat locally to the coated polyethylene surface sufficiently to fuse the coating into the surface of the polyolefin part, a condition which is reached when the coated surface appears to be clear of any cloudiness. Thereafter, the polyolefin part is cooled to ambient temperature.

The invention is further described and illustrated in the following examples.

### EXAMPLE 1

An anti-microbial composition is prepared by blending an anti-microbial additive with a polyolefin fusible solid. The additive is a ceramic alumino-silicate containing approximately 2.5 weight percent silver and 1.5 weight percent zinc and having an average size of one micron.

In the first experiment, the polyolefin fusible solid is a mixture of 90 weight percent high density polyethylene having a melt index of 10 and a mean particle size of 20 microns and 10 weight percent aliphatic hydrocarbon resin with softening point of about 85 degrees C. and a Brookfield viscosity of 100 centipoise at 177 degrees C.

In a second experiment. the polyolefin fusible solid is 100 percent of the aliphatic hydrocarbon resin.

In a third experiment the polyolefin fusible solid is a mixture of 75 weight percent high density polyethylene having a melt index of 2000 and 25 weight percent of the aliphatic hydrocarbon resin.

### EXAMPLE 2

The anti-microbial compositions prepared in Example 1 are diluted to 30 weight percent concentration in hexane. A rotational mold to manufacture one inch thick hollow form boards ten by sixteen inches is sprayed with the diluted compositions in successive experiments. The mold is at a temperature between 90 degrees and 125 degrees F. when sprayed with the compositions. After spraying with each of the diluted compositions, the mold is charged with polyethylene molding resin (35 mesh), closed and heated to approximately 550 degrees F., while being rotated about its major and minor axes for 15 minutes. The mold is then cooled, opened and the hollow-form board is ejected. The boards are tested for silver concentration at the outer surface using a standard atomic absorption test in which values greater than 30 ppb exhibit acceptable anti-microbial activity. The boards coated with the compositions of experiments 1 and 2 tested, respectively 50 and 170 ppb silver. The board coated with the composition of experiment 3 tested 0 ppb silver.

### EXAMPLE 3

A sample of the anti-microbial compositions prepared in the first experiment of Example 1 is diluted to a 30 weight percent concentration in hexane and a second sample of the same composition is dispersed in water at a concentration of 30 weight percent. Preformed one inch thick hollow form boards ten by sixteen inches are sprayed with the diluted compositions in successive experiments. In each experiment, the coated board is heated with an infrared heater to approximately 270 degrees F. The boards are tested for surface silver concentration using the aforementioned atomic absorption test. The board treated with the hexane solution of the anti-microbial composition tested 320 ppb silver and the board treated with the water dispersion of the anti-microbial composition tested 185 ppb silver; both results indicating acceptable anti-microbial activity.

The invention has been described with reference to the illustrated and presently preferred embodiment. It is not intended that the invention be unduly limited by this disclosure of the preferred embodiment. Instead, it is intended that the invention be defined by the elements, and their obvious equivalents, set forth in the following claims.

What is claimed is:

1. A method to impart anti-microbial activity to the surface of a polyolefin object which comprises:
a. coating the surface with an anti-microbial composition comprising:
i. from 0.5 to 5 weight percent of an anti-microbial metal selected from the group consisting of elemental and ionic silver, zinc, copper and cadmium deposited on a solid carrier, and
ii. from 95 to 99.5 weight percent of a polyolefin fusible solid selected from the group consisting of a hydrocarbon resin having a viscosity at 177 degrees C. in excess of 20, a polyolefin having a melt index less than 50, and mixtures thereof; and
b. heating the surface to a temperature at least 250 degrees F. for sufficient time to fuse the coating into the wall of said object.

2. The method of claim 1 wherein said anti-microbial metal is silver.

3. The method of claim 1 wherein said carrier solid is an ion-exchange solid and said anti-microbial metal is ion-exchanged onto said carrier solid.

4. The method of claim 3 wherein said ion-exchange solid is zeolite.

5. The method of claim 3 wherein said anti-microbial metal includes zinc.

6. The method of claim 1 wherein said polyolefin fusible solid is polyethylene.

7. The method of claim 1 wherein said polyolefin fusible solid includes a hydrocarbon resin.

8. In a rotational molding method for fabrication of a hollow form plastic product in a rotational molding cycle wherein plastic particles are charged to a rotational mold, the mold is closed, heated to a molding temperature while being rotated about its major and minor axes for a time sufficient to form said molded product and the mold is cooled to a demolding temperature, opened and the molded product is ejected, the improved method for imparting anti-microbial activity to the exterior surface of said molded product which comprises:
applying to a selected area of the interior surface of said rotational mold at substantially the demolding temperature a coating comprising
i. from 0.5 to 5 weight percent of an anti-microbial metal selected from the group consisting of elemental and ionic silver, zinc, copper and cadmium deposited on a solid carrier, and
ii. from 95 to 99.5 weight percent of a polyolefin fusible solid selected from the group consisting of a hydrocarbon resin having a viscosity at 177 degrees F. in excess of 20, a polyolefin having a melt index less than 50, and mixtures thereof; and
b. continuing said rotational molding cycle to obtain a molded, hollow form plastic product having said anti-microbial composition fused into the wall of said product.

9. The method of claim 8 wherein said anti-microbial metal is silver.

10. The method of claim 8 wherein said carrier solid is an ion-exchange solid and said anti-microbial metal is ion-exchanged onto said carrier solid.

11. The method of claim 10 wherein said ion-exchange solid is zeolite.

12. The method of claim 10 wherein said anti-microbial metal includes zinc.

13. The method of claim 8 wherein said polyolefin fusible solid is polyethylene.

14. The method of claim 8 wherein said polyolefin fusible solid includes a hydrocarbon resin.
